(19) United States
(12) Patent Application Publication
(10) Pub. No.: US 2008/0307157 A1
(43) Pub. Date: Dec. 11, 2008

(54) Method and system for updating firmware of microcontroller

(76) Inventors: Yi-Feng Jang, Taishan Township (TW); Rui-Qing Wei, Shanghai (CN)

Correspondence Address: ROSENBERG, KLEIN & LEE, 3458 ELLICOTT CENTER DRIVE-SUITE 101, ELLICOTT CITY, MD, 21043, US

(21) Appl. No.: 11/808,015

(22) Filed: Jun. 6, 2007

(51) Int. Cl. G06F 12/06; G06F 13/38

(52) U.S. Cl. 711/103; 710/63; 711/E12.008

(57) ABSTRACT

A system for updating firmware of a microcontroller includes a serial peripheral interface (SPI), an inter integrated Circuit (I²C or IIC) and a universal serial bus (USB) for the flexibility of using these interfaces. And, a method for updating firmware of a microcontroller is also provided to utilize each interface more efficiently.

### BACKGROUND OF THE INVENTION

1. Field of the Invention

The present invention relates to a method and a system for updating firmware, and more particularly to a method and a system for updating firmware of a microcontroller.

2. Description of the Related Art

In recent years, the 3C (Computer, Communication, Consumer-electronics) products are developed rapidly, and users have to update the firmware of new products from time to time in order to improve the compatibility and performance of the product or debug the new product whenever a bug is found. As to system manufacturers, the procedure of updating firmware is similar to provide another piece of integrated circuit (IC) such as a microcontroller unit (MCU). Although the IC manufacturers may provide a firmware program, most of the firmware provided by the IC manufacturers are used for the purpose of testing hardware, and thus the function and structure are incomplete. If the system manufacturers can update or upgrade a firmware conveniently, then the add-on value of the IC will be increased significantly. In general, the firmware of a microcontroller is usually stored in an on-chip program memory including a non-volatile memory such as a flash memory or an electrically erasable programmable read only memory (EEPROM) of the microcontroller. With the issues of expiration and cost, a volatile memory such as a static random access memory (SRAM) is used for developing an on-chip program memory. In the applications of a microcontroller of this sort, it is necessary to install an additional off-chip program memory such as an EEPROM, such that if the microcontroller is powered on, the firmware stored in the EEPROM will be loaded into the on-chip program memory to overcome the aforementioned shortcoming.

In general, a firmware can be updated through two pins, three pins or four pins reserved at the time of developing a microcontroller, but these pins are defined by a manufacturer's specification, and thus the update must be done by the manufacturers, and thus causing tremendous inconvenience to end-users. Furthermore, the firmware is downloaded into a host such as a host computer system or a mobile phone first, and then a universal serial bus (USB) is used for loading the firmware stored in the host into the on-chip program memory of the microcontroller to update a firmware. The universal serial bus (USB) is a standard interface jointly introduced and promoted by seven companies including Intel, Compaq, Digital, IBM, Microsoft, NEC and Northern Teleco and the USB is used extensively. The method of updating a firmware through the universal serial bus (USB) is very simple and convenient, and users simply need to give instructions from the host.

Other interfaces such as the inter integrated circuit (I²C or IIC) interface introduced by Philips Company and serial peripheral interface (SPI) introduced by Motorola Company are also used for updating firmware.

The I²C is a two-wire communication interface, and these two wires are a serial data line (SDA) and a serial clock line (SCL), and the SDA is provided for inputting/outputting data, and the SCL is provided for generating a clock. All devices on the I²C are connected by these two wires, and each of these devices can be operated at a master mode or a slave mode as needed. Therefore each device on the I²C requires a unique address for identification. More specifically, if a certain device is a master device and the rest of the devices are slave devices, then the master device will broadcast to all devices on the I²C and send out the address of the desired communicating slave device, such that that particular slave devices will send out an acknowledge and start connecting to the master device for the communication and data transmission, but other slave devices will not acknowledge. After the communication is completed, the slave device returns to the initial status and waits for the next operation.

SPI is a four-wire communication interface, wherein the three wires of Master Out Slave In (MOSI), Master In Slave Out (MISO), Serial Clock (SCK) are provided for transmitting data, and the wire of Slave Select (SS) line is provided for selecting a control device. More specifically, a master device provides the clock and issues the operations of reading or writing the slave device. If several slave devices exist on the interface and issue a transmission, then the master device will lower the electric potential of the slave select line of the slave devices, and then start transmitting or receiving data through the MOSI and the MISO circuits. Compared with the I²C, the SPI generally achieves a higher transmission speed.

In the microcontroller introduced by Cypress Semiconductor Company, the system for updating firmware is shown in FIG. 1, and the firmware of a microcontroller 102 is stored in an on-chip program memory 108, and both interfaces: an inter integrated circuit (I²C or IIC) 112 and a universal serial bus (USB) 114 of the microcontroller 102 are provided for updating firmware. Since the inter integrated circuit (I²C or IIC) is very popular, if the inter integrated circuit (I²C or IIC) 112 is occupied by an inter integrated circuit (I²C or IIC) external device 126 for other purposes, then it cannot be used for updating the firmware, and thus a universal serial bus (USB) 114 is used for updating the firmware, and the application become lack of flexibility.

Therefore, it is necessary to provide a system and a method for integrating each of the foregoing interfaces.

### SUMMARY OF THE INVENTION

In view of the shortcomings of the way of updating a firmware according to Cypress Semiconductor, the serial peripheral interface (SPI) of Motorola can be used for updating the firmware, if the inter integrated circuit (I²C or IIC) is occupied by other devices, and the serial peripheral interface (SPI) of Motorola can be added. On the other hand, the inter integrated circuit (I²C or IIC) can be used for updating a firmware, if the serial peripheral interface (SPI) is occupied by other devices, and such arrangement makes the application more flexible.

Therefore, it is a primary objective of the present invention to provide a system for updating firmware of a microcontroller, comprising: an on-chip program memory for storing a firmware, at least one external device for storing a new firmware, a firmware loader having a plurality of interfaces, and the plurality of interfaces include a serial peripheral interface (SPI), an inter integrated circuit (I²C or IIC) and a universal serial bus (USB), wherein the firmware loader loads a new firmware into the on-chip program memory through the plurality of interfaces to update the firmware. The invention can increase the flexibility of using the interfaces.

Another objective of the present invention is to provide a method for updating a firmware of a microcontroller that comprises the steps of: providing an on-chip program memory in the microcontroller for storing a firmware; testing whether or not an off-chip program memory exist; detecting whether or not at least one interface boot device in a serial peripheral interface (SPI) boot device and an inter integrated circuit (I²C or IIC) boot device is enabled, if the off-chip program memory does not exist; detecting whether or not an external device corresponding to at least one interface boot device is a storage element, if at least one interface boot device is enabled; detecting whether or not the storage element stores a new firmware, if the external device is a storage element; and loading the new firmware into the on-chip program memory to update the firmware, if the storage element stores a new firmware.

### BRIEF DESCRIPTION OF THE DRAWINGS

FIG. 1 is a system block diagram of a microcontroller firmware updated by Cypress Semiconductor Company;

FIG. 2 is a system block diagram of updating a microcontroller firmware in accordance with a preferred embodiment of the present invention;

FIG. 3 is a flow chart of a method of updating a microcontroller firmware in accordance with a preferred embodiment of the present invention;

FIG. 4 shows an example of a list of storage elements that store firmware;

FIG. 5 shows an example of a list of storage elements that do not store firmware; and

FIG. 6 shows an example of the definition of a lave address of an EEPROM with respect to an inter integrated circuit (I²C or IIC).

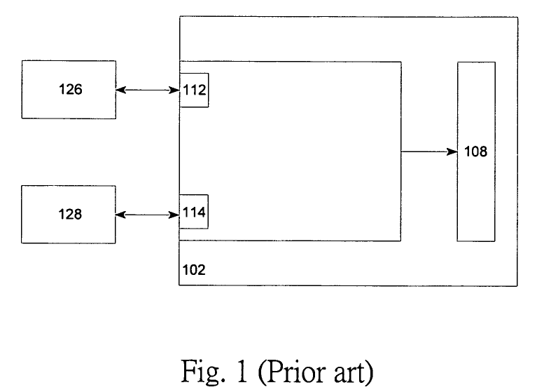

### DETAILED DESCRIPTION OF THE PREFERRED EMBODIMENTS

To make it easier for our examiner to understand the technical characteristics of the invention, we use a preferred embodiment together with the attached drawings for the detailed description of the invention.

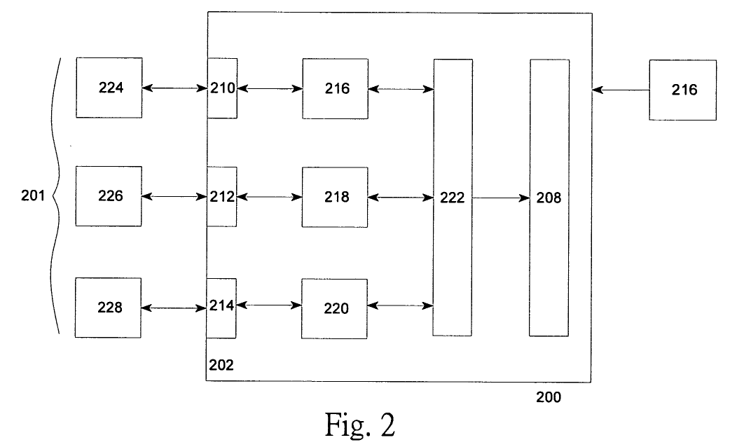

The present invention discloses a system and a method for updating a firmware of a microcontroller. FIGS. 2 and 3 and FIGS. 4-6 illustrate the present invention in details.

Referring to FIG. 2 for a system of updating a firmware in accordance with a preferred embodiment of the present invention, the system 200 for updating a firmware comprises an on-chip program memory 208 and a firmware loader 204 installed in a microcontroller 20, and an external device 201. The on-chip program memory 208 is provided for storing a firmware, and the firmware loader 204 has a plurality of interfaces including a serial peripheral interface (SPI) 210, an inter integrated circuit (I²C or IIC) 212, and a universal serial bus (USB) 214. These three interfaces are connected to a serial peripheral interface (SPI) boot device 216, an inter integrated circuit (I²C or IIC) boot device 218, and a universal serial bus (USB) boot device 220. If the interface is connected to one or more external devices 201, such as the serial peripheral interface (SPI) 210 is connected to a flash memory or an electrically erasable read only memory (EEPROM) 224, the inter integrated circuit (I²C or IIC) 212 is connected to an EEPROM 226, or the universal serial bus (USB) 214 is connected to a host computer system 228, then the corresponding interface boot devices 216, 218, 220 will be enabled. In other words, an enabled interface boot device indicates that an external device 224, 226 or 228 exists at the corresponding interface. These external devices include a serial peripheral interface (SPI) external device 224 on the serial peripheral interface (SPI), an inter integrated circuit (I²C or IIC) external device 226 on the inter integrated circuit (I²C or IIC) interface, and a universal serial bus (USB) external device 228 on the universal serial bus (USB) interface. It is noteworthy to point out that the external device 201 includes various different serial peripheral interfaces (SPI), inter integrated circuit (I²C or IIC) or universal serial bus (USB) supporting hardware, such as the storage element of a memory, a host computer system or other electronic components. Even if a storage element exists on these interfaces, the storage element may not be able to store a firmware, but only can store data other than the firmware. Therefore, the firmware loader 204 further includes a determination device 222 for determining whether or not the external device 201 is a storage element, and determining whether or not the firmware is stored in the storage element.

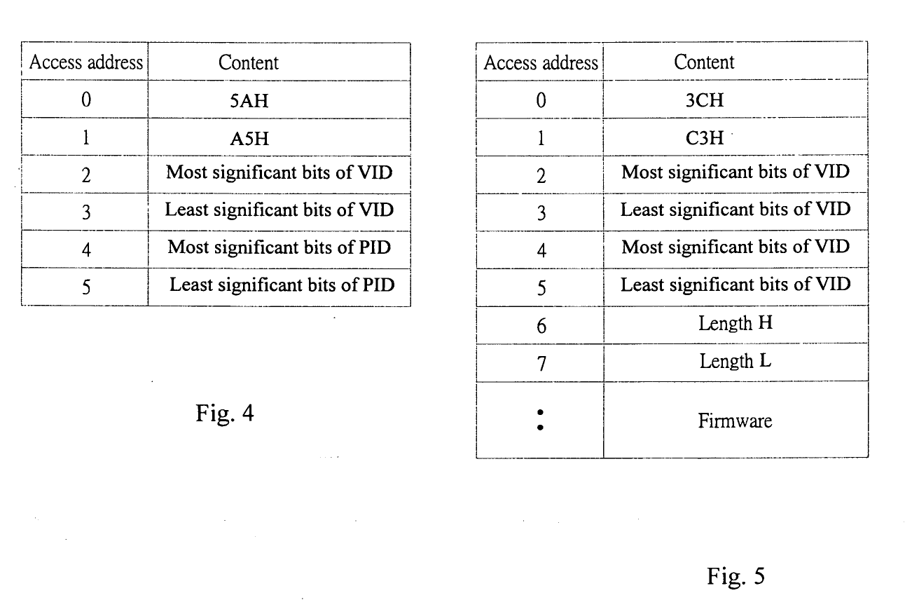

In the process of determining whether or not the storage element is stored in the firmware in accordance to some embodiments, the storage element can be designed with a bit of a specific address which is used as a basis for the determination as shown in FIGS. 4-5. FIG. 4 shows an example of a list of storage elements that do not store firmware and FIG. 5 shows an example of a list of storage elements that store firmware. If the determination device 222 reads 3CH from the access address 0 and reads C3H from the access address 1, the storage element is determined to store the firmware as shown in FIG. 5. On the other hand, if 5AH is read from the access address 0 and A5H is read from the access address 1, then it indicates that the storage element only stores data other than the firmware as shown in FIG. 4. If the storage element 224, 226, 228 on the plurality of interfaces has firmware, then the determination device 222 can be used for one interface selected from the plurality of interfaces, and the firmware stored in the storage element 224, 226, 228 on the selected interface is loaded into on-chip program memory 208 to complete the operation of updating the firmware.

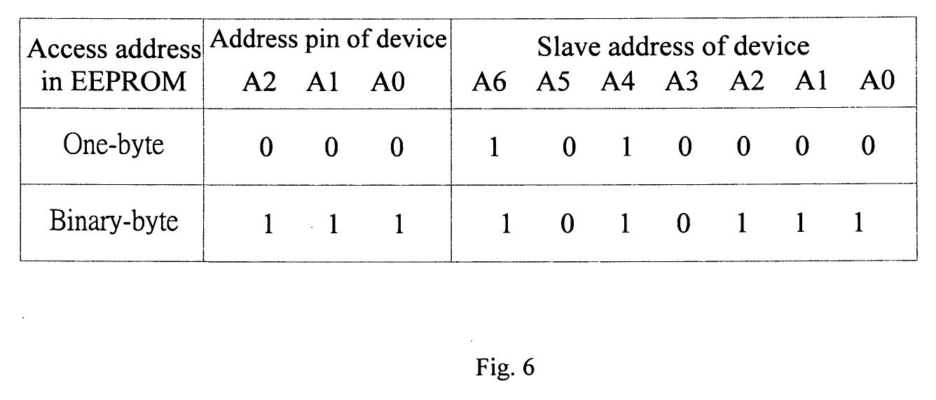

Since the capacity of these storage elements varies, it is necessary to send out an access address of different length for accessing these storage elements in addition to the determination whether or not the external device 201 is a storage element. In some embodiment of the inter integrated circuit (I²C or IIC) 212, the determination device 222 can send out a request to a component corresponding to the slave address. If an acknowledge signal is received, then it indicated that the storage element exists. Referring to the definition of FIG. 6, the definition of the slave address is described in details, wherein FIG. 6 uses a 7-bit address for the illustration. The first four most significant bits in the 7-bit slave address is fixed and classified according to the device; for example, 1010B indicates the EEPROM, and the last three least significant bits are set through the address pin of the device; for example, Pins A2, A1 and A0 are filled with 0,0,0 or 1,1,1, and then a portion of the least significant bits of the slave address can be determined to be 000B or 111B. In addition, a portion of the least significant bits of the slave address can be designed in a binary value according to the pin design, and thus the same inter integrated circuit (I²C or IIC) 212 can have 8 devices of the same type. In general, a length of one to three bytes is generally used for the access address depending on the memory capacity of the EEPROM, and the slave address of the inter integrated circuit (I²C or IIC) 212 can be programmed according to the pins, such that a portion of the least significant bits of different slave addresses can be used for indicating the length of different access addresses. For instance, a portion of least significant bits of some slave addresses represent the EEPROM of less than 256 bytes, and the EEPROM is defined as Type A, wherein a byte is used to indicate the access address of Type A EEPROM; and another portion of the least significant bits of certain slave addresses represent an EEPROM type greater than 256 bytes and less than 64K bytes and the EEPROM is defined as Type B, wherein two bytes are used to indicate the access address of Type B EEPROM. In the definition of FIG. 6, the determination device 222 can send out a first request to an inter integrated circuit (I²C or IIC) external device 226 having a slave address of 1010000B first, such that if a first acknowledge signal is received, then the external device is a Type A EEPROM 226. If it is necessary to read the stored content of the Type A EEPROM 226, then a one-byte access address is sent out. If the first acknowledge signal is not received, then a second request is sent to an inter integrated circuit (I²C or IIC) device external 226 with a slave address of 1010111B, such that if a second acknowledge signal is received, then the external device is determined as a Type B EEPROM 226. If it is necessary to read the stored content of the Type B EEPROM 226, then a two-byte access address is sent. If the second acknowledge signal is still not received, then it is determined that there is no EEPROM in the inter integrated circuit (I²C or IIC) external device 226. It is noteworthy to point out that the description above uses an EEPROM and a portion of the most significant bits 1010B of a slave address corresponding to the EEPROM for illustration, and only defines the Type A and Type B EEPROMs, and the persons skilled in the art should know that the determination device 222 can determine whether or not another type of EEPROM of another type of storage element exists in an inter integrated circuit (I²C or IIC) external device 226 by the same method as described above.

In the process of determining whether or not an external device 201 is a storage element accordance with another preferred embodiment, the serial peripheral interface (SPI) 210 has an additional slave select (SS) line than the inter integrated circuit (I²C or IIC), and thus the determination device 222 can determine whether or not the storage element has a firmware by the foregoing method. If it is necessary to access a storage of a different memory capacity, then an access address of a different length is required, and thus this embodiment will send out a two-byte access address to a serial peripheral interface (SPI) external device 224 to read data corresponding to the access address. If the read data matches with the preetermined definition, then the serial peripheral interface (SPI) external device 224 is determined to have a storage element. If the read data does not match with the definition, then a three-byte access address is sent to a serial peripheral interface (SPI) external device 224 to read data corresponding to the access address. If the read data matches with the predetermined definition, then the serial peripheral interface (SPI) external device 224 is determined to have a storage element. If the read data does not match with the definition, then it is determined that there is no storage element in the serial peripheral interface (SPI) external device 224. It is noteworthy to point out that two-byte and three-byte storage elements are used for illustration, but the persons skilled in the art should know that the foregoing method can be used to determine a storage element of a different capacity.

It is noteworthy to point out that in the foregoing embodiment of determining whether or not an external device 201 is a storage element and whether or not a storage element has a firmware, the firmware will not be updated, if the storage element or firmware does not match with the previous defined specification. As shown in FIG. 5, if the bits read from a specific address is not equal to the previously defined 3CH (but equal to C3H), then the determination device 222 will consider the firmware actually stored in the storage element as not a firmware.

An off-chip program memory 206 as shown in FIG. 2 is provided for expanding the on-chip program memory 208. For instance, the 8051 single chip comes with 4K bytes of a built-in on-chip program memory 208 and is expandable to 64K bytes of program memory, so that the additional 60K bytes of off-chip program memory 206 can be added. If the off-chip program memory 206 exists, then the firmware loader 202 will be disenabled.

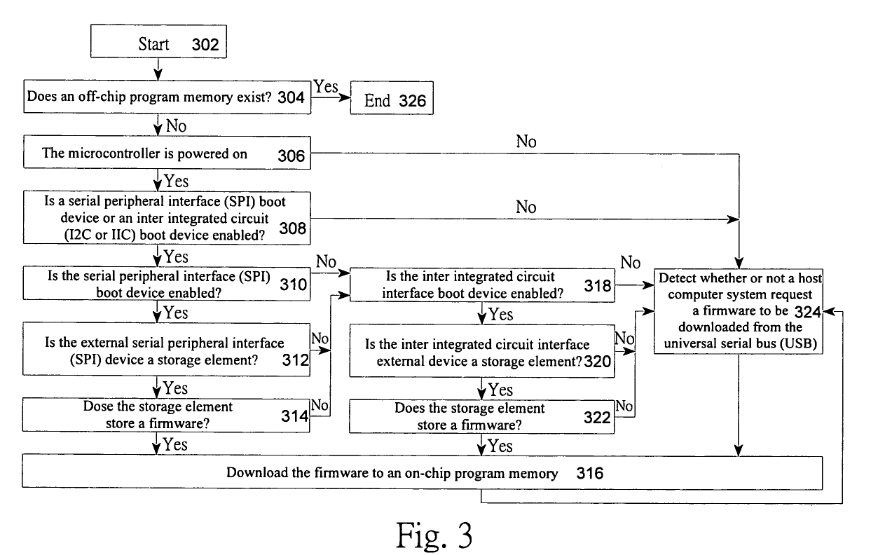

Referring to FIG. 3 for a method of updating a firmware in accordance with a preferred embodiment of the present invention, the method comprises that steps of detecting whether or not an off-chip program memory 304 exists, after the start 302 of this method 300; if no, then detecting whether or not the microcontroller is powered on 306; if yes, then detecting whether or not a serial peripheral interface (SPI) boot device or an inter integrated circuit (I²C or IIC) boot device is enabled; if yes, then detecting whether or not this serial peripheral interface (SPI) boot device is enabled 310; if yes, then detecting whether or not a serial peripheral interface (SPI) external device corresponding to this serial peripheral interface (SPI) is a storage element 312; if no, then detecting whether or not the storage element has a firmware 314; if yes, then downloading the firmware into an on-chip program memory 316 of the microcontroller. Now, return to Step 304. If an off-chip program memory exists, then end 326 the procedure. Now, return to Step 306. If the microcontroller is not powered on, then a step is carried out for detecting whether or not a host computer system requests a firmware 324 to be downloaded from the universal serial bus (USB) interface. Now, return to Steps 310, 312 and 314. If the serial peripheral interface (SPI) boot device is not enabled, then the external device corresponding to the serial peripheral interface (SPI) is not a storage element and the storage element does not store a firmware. A step is carried out for determining whether or not an inter integrated circuit interface boot device is enabled 318. If yes, then a step will be carried out for detecting whether or not the inter integrated circuit (I²C or IIC) external device corresponding to the inter integrated circuit interface is a storage element 320. If yes, then a step will be carried for detecting whether or not the storage element has a firmware 322. If yes, then the firmware will be downloaded into an on-chip program memory 316 of the microcontroller. Now, return to Steps 318, 320 and 322. If the inter integrated circuit interface boot device is not enabled, the inter integrated circuit interface external device is not a storage element, and the storage element does not store a firmware, then a step is carried out for detecting whether or not a host computer system requests the firmware 324 to be downloaded from the universal serial bus (USB) interface. Now, go to Step 324. If a request from the host computer system is detected, then the firmware is downloaded to the on-chip program memory 316 according to the request. Some embodiments return the procedure to Step 324 after Step 316 is completed, and wait for a next request from the host computer system. If a host computer system sends out a request for updating firmware at anytime, the universal serial bus (USB) interface is used to download the firmware previously stored in the host computer system into the on-chip program memory in accordance with a preferred embodiment as shown in FIG. 3. In other embodiments, the procedure can return to Steps 326, Step 308 or other steps as needed, after Step 316 is completed.

In a preferred embodiment as shown in FIG. 3, the steps are carried out for detecting whether or not a serial peripheral interface (SPI) boot device is enabled 310, and then detecting whether or not an inter integrated circuit (I²C or IIC) boot device is enabled 318. In another preferred embodiments, the present invention detects whether or not an inter integrated circuit (I²C or IIC) boot device is enabled and then detects whether or not a serial peripheral interface (SPI) boot device is enabled.

While the invention has been described by means of specific embodiments, numerous modifications and variations could be made thereto by those skilled in the art without departing from the scope and spirit of the invention set forth in the claims.

What is claimed is:

1. A system for updating a firmware of a microcontroller, comprising:
an on-chip program memory for storing said firmware;
a firmware loader having a plurality of interfaces including a serial peripheral interface, an inter integrated circuit interface and a universal serial bus interface; and
at least one external device for storing a new firmware;
wherein said firmware loader loads said new firmware into said on-chip program memory through said plurality of interfaces to update said firmware.

2. The system of claim 1, wherein said external device communicates with said serial peripheral interface.

3. The system of claim 1, wherein said external device communicates with said inter integrated circuit interface.

4. The system of claim 1, wherein said external device is disposed in a host computer system and communicates with said universal serial bus interface.

5. The system of claim 1, wherein said firmware loader further comprises:
a plurality of interface boot devices coupled with said plurality of corresponding interfaces respectively;
a determination device coupled with said plurality of interface boot devices, for detecting whether or not said external device stores a new firmware, and selecting an interface boot device from said plurality of interface boot devices to load said new firmware into said on-chip program memory.

6. The system of claim 5, wherein said plurality of interface boot devices include:
a serial peripheral interface boot device;
an inter integrated circuit boot device; and
a universal serial bus boot device.

7. The system of claim 1, wherein said microcontroller further comprises an off-chip program memory for disabling said firmware loader.

8. A method for updating a firmware of a microcontroller, comprising the steps of:
(a) providing an on-chip program memory in said microcontroller for storing said firmware;
(b) testing whether or not an off-chip program memory exists;
(c) detecting whether or not at least one interface boot device of a serial peripheral interface boot device and an inter integrated circuit boot device is enabled, if said off-chip program memory does not exist;
(d) detecting whether or not an external device corresponding to said at least one interface boot device is a storage element, if said at least one interface boot device is enabled;
(e) detecting whether or not said storage element stores a new firmware, if said external device is a storage element;
(f) loading said new firmware into said on-chip program memory to update said firmware, if said storage element stores a new firmware.

9. The method of claim 8, wherein said at least one interface boot device is enabled, such that said serial peripheral interface boot device is enabled, but said inter integrated circuit boot device is not enabled.

10. The method of claim 8, wherein said at least one interface boot device is enabled, such that said inter integrated circuit boot device is enabled, but said serial peripheral interface boot device is not enabled.

11. The method of claim 8, wherein said at least one interface boot device is enabled, such that said serial peripheral interface boot device and said inter integrated circuit boot device are enabled.

12. The method of claim 11, wherein said step (e) further comprises:
detecting whether or not said external device corresponding to said serial peripheral interface boot device stores a new firmware.

13. The method of claim 11, wherein said step (e) further comprises:
detecting whether or not said external device corresponding to said inter integrated circuit boot device stores a new firmware.

14. The method of claim 8, wherein said step (c) further comprises:
detecting whether or not a request comes from a host computer system for updating said firmware through a universal serial bus interface, if said serial peripheral interface boot device and said inter integrated circuit boot device are not enabled; and
loading said new firmware into said on-chip program memory through said universal serial bus interface to update said firmware, if said request exists.

15. The method of claim 8, wherein said step of detecting whether or not at least one interface boot device of a serial peripheral interface boot device and an inter integrated circuit boot device is enabled is carried out only if said microcontroller is powered on.
